(19) United States
(12) Patent Application Publication
(10) Pub. No.: US 2024/0132781 A1
(43) Pub. Date: Apr. 25, 2024

(54) RESOURCE RECOVERY FROM WOOD WASTES

(71) Applicant: The Crucible Group IP Pty Ltd, Paddington (AU)

(72) Inventors: Joseph George Herbertson, Mayfield (AU); Lazar Strezov, Adamstown Heights (AU); Kannappar Mukunthan, Garden Suburb (AU)

(21) Appl. No.: 18/400,691

(22) Filed: Dec. 29, 2023

Related U.S. Application Data
(63) Continuation of application No. 16/329,786, filed on Mar. 1, 2019, now abandoned.

(30) Foreign Application Priority Data
Aug. 31, 2016 (AU) 2016903495

(51) Int. Cl. C10B 53/02; C10B 7/10; C10B 21/10; C10B 49/04; C10B 57/10; C10G 1/04

(52) U.S. Cl. CPC C10B 53/02; C10B 7/10; C10B 21/10; C10B 49/04; C10B 57/10; C10G 1/045; C10G 2300/1014; C10G 2300/205; C10G 2300/30

(57) ABSTRACT

A method and an apparatus for processing wood wastes and producing valuable products that are safe and have economic value is disclosed. The apparatus includes a continuous converter (3) for a feed material that includes wood wastes containing contaminants. The continuous converter includes a reaction chamber (5) for producing a solid carbon-containing product, a gas product, and optionally a liquid oil product and a separate water-based condensate product in the chamber, via pyrolysis or other reaction mechanisms.

### CROSS-REFERENCE TO RELATED APPLICATIONS

This application is a continuation of U.S. patent application Ser. No. 16/329,786, filed Mar. 1, 2019, which is the national phase of PCT/AU2017/050946, which claims priority to AU 2016903495. The foregoing applications are incorporated herein by reference.

### TECHNICAL FIELD

The present invention relates to a method of processing wood wastes and producing safe products that have economic value.

### BACKGROUND ART

There are considerable amounts of wood wastes that are generated each year.

The term “wood wastes” is understood herein to mean wood off-cuts or shavings etc. produced in the course of manufacturing wood products, reject wood products, and discarded wood products, for example as a result of renovating houses or offices. Wood wastes may include composite products that include wood and other components. One example is kitchen bench tops that comprise a wood base and a top surface of a plastics material or other material that is laminated or otherwise fixed to the base.

Specific examples of wood wastes are engineered timbers, blue pine, wood wastes with plastics, painted timber, and wood wasted with metals.

A significant proportion of wood wastes contain contaminants. The contaminants may include organic materials such as resins, glues, paints etc. that make it difficult to cost-effectively process the wood wastes for use as or in new products. The contaminants may also include heavy metals.

Organic contaminants include organic materials that are added to wood to improve longevity of wood products—creosote, pymetheroid treatments. Heavy metals may be in wood products as a result of processing or use of the wood products and present in trace amounts. Heavy metals may also be added deliberately to wood in trace or higher amounts, such as copper, chrome, and arsenic use to treat timber. The term “trace” is understood to mean up to 500 ppm and typically less than 100 ppm.

In this context, the term “contaminant” does not necessarily mean that the materials are toxic, although this may be the case.

The term “contaminant” is understood herein in the wider context of materials that have to be separated from the wood in wood wastes to allow the wood to be used in new products.

As a consequence, it is often the case that current options for processing wood wastes to remove contaminants are not economically viable and the only option for the wood wastes is in land fill.

There is a need for alternative options for processing wood wastes than the currently-available options.

The above description is not to be taken as an admission of the common general knowledge in Australia and elsewhere.

### SUMMARY OF THE DISCLOSURE

The applicant has developed a method and an apparatus for converting biomass or other solid organic feed materials via pyrolysis or other mechanisms to valuable products such as but not confined to any one or more of a liquid water product (which can be described in general terms as a water-based condensate and in some instances as “wood vinegar”), a liquid oil product, a gas product, and a solid carbon-containing product such as a char product.

The method and the apparatus are hereinafter referred to collectively as the “continuous biomass converter” technology.

The term “biomass” is understood herein to mean living or recently living organic matter. Specific biomass products include, by way of example, forestry products (including mill residues such as wood shavings), agricultural products, biomass produced in aquatic environments such as algae, agricultural residues such as straw, olive pits and nut shells, animal wastes, municipal and industrial residues.

The term “organic feed materials” includes biomass, peat, coal, oil shales/sands, plastic waste materials, and also includes blends of these feed materials.

The above-mentioned continuous biomass converter technology is described and claimed in patent families that include International applications PCT/AU2009/000455 (WO2009/124359) and PCT/AU2014/001020 (WO2015/061833) in the name of the applicant. The disclosure in the patent specifications of these patent applications is incorporated herein by cross-reference.

The continuous biomass converter technology of the applicant combines the functions of drying, char making, tar cracking and gas scrubbing into a single stage, continuous and automatically controlled reactor operating under quite unique thermo-chemical conditions. The continuous biomass converter technology makes it possible to achieve high efficiencies and streamlined engineering, which has considerable advantages when compared to available pyrolysis and gasification options.

The applicant has identified operating conditions that make the continuous biomass converter technology particularly effective for processing wood wastes and producing valuable products that are safe and have economic value.

In particular, the applicant has found in research and development work on wood wastes provided by Laminex Group that the the continuous biomass converter technology of the applicant can:
(a) decompose organic material contaminants in these wood wastes and incorporated decomposed products into useful products; and
(b) deport at least a significant proportion of heavy metal contaminants in these wood wastes to a char product, with the char product being a preferable medium for the heavy metals than the liquid and gas products, and with the heavy metals being recoverable from the char product if the levels are sufficiently high to warrant recovery.

In broad terms, in accordance with the present invention, a feed material comprising wood wastes containing contaminants is supplied to an apparatus in the form of a continuous converter and moved through a reaction chamber of the converter, typically in a packed bed form, more particularly a closely packed bed form, and exposed to a time-temperature profile within the chamber that dries and pyrolyses or otherwise processes by another reaction mechanism the feed material and produces a solid carbon-containing product (such as a char product) and releases water vapour and a volatile products gas phase, with organic material contaminants in the wood wastes being decomposed altogether or converted into useful products effectively, and with heavy metal contaminants in the wood wastes being deported to the solid carbon-containing product.

Typically, the converter is positioned so that the reaction chamber is horizontally disposed. It is noted that the converter, and more particularly the chamber, may be slightly inclined or vertical.

The water vapour and volatile products gas phase move counter-current to the feed material in the chamber. At least a part of the condensable components of the volatile products in the gas phase condense in cooler upstream sections of the chamber and form liquid oil (i.e. a liquid oil-based condensate) and tar. Typically, the operating temperatures are such that water vapour does not condense in the chamber and discharges from the chamber as part of the gas phase and condenses as liquid water product outside the chamber.

The condensed liquid oil and tar are carried forward in the reaction chamber by the feed material to the higher temperature regions of the chamber and are progressively volatilised and cracked to hydrogen, carbon monoxide, carbon dioxide and short chain hydrocarbons such as methane, ethane, and other light hydrocarbons. The end result of the condensation and cracking/volatilisation cycle is that a gas product comprising water vapour and non-condensable gases at the temperature and pressure within the chamber is discharged from the chamber.

There may be circumstances where it is desirable to drain a part of the liquid oil from the chamber as a separate product.

The materials that are contaminants in wood wastes may be as described above.

For example, contaminants in wood wastes may include organic materials such as resins, glues, paints etc. that make it difficult to cost-effectively process the wood wastes for use as or in new products. By way of further example, contaminants may include heavy metals.

The contaminants may be the result of the use of the wood products or because the contaminants were added deliberately to improve longevity of the wood products.

The gas generated from the feed materials is clean burning with respect to potentially harmful organic substances, due to internal cracking and thermal decomposition of long chain, complex molecules in the reaction chamber of the converter. The gas exits the continuous biomass converter at very low temperatures compared to typical thermal processes (well below 100° C.), after flowing through the packed bed of input feed material moving counter currently (these are distinctive features of the continuous biomass converter technology). Consequently, there is gas scrubbing as the gas moves towards the cold end of the reaction chamber and minimal opportunity for metal transfer from the feed material to the gas.

The continuous biomass converter operates under reducing conditions (not combustion or incineration).

Whilst the continuous biomass converter technology incorporates pyrolysis reactions, it is more than a pyrolyser, since it includes drying, tar cracking, and gas scrubbing within the reactor. In other pyrolysis systems, these functions typically take place in separate unit operations, under different conditions to those prevailing in the continuous biomass converter technology.

The features of the continuous biomass converter technology that the applicant has identified as being important for processing wood wastes include the following features:
1. The continuous biomass converter technology is a sealed system and therefore contaminants in wood wastes are completely contained during processing in the apparatus.
2. The feed inlet to the main chamber of the apparatus is maintained at a small negative pressure, ˜ 50 Pa, as an additional protection against gas escaping from the apparatus.
3. The time-temperature profile within the reaction chamber of the apparatus, typically 200-600° C. over a period of 5-20 minutes, typically 7-15 minutes, is controlled to decompose organic contaminants in wood wastes.
4. The thermo-chemical conditions in the reaction chamber of the apparatus are controlled to be reducing to ensure high carbonisation of the char product.
5. The process conditions, such as gas exit temperatures (typically controlled to be less than 100° C. at the outlet, typically less than 90° C., typically of the order of 80° C.) ensures that heavy metal contaminants present in the wood waste are retained with the solid carbon-containing product and not present as vapour in the gas phase and transported to the gas and the liquid product from.

In broad terms, the present invention provides an apparatus for processing wood wastes and producing valuable products that are safe and have economic value, the apparatus including a continuous converter for a feed material that includes wood wastes containing contaminants, with the continuous converter including a reaction chamber for producing a solid carbon-containing product, a gas product, and optionally a liquid water product in the chamber, via pyrolysis or other reaction mechanisms, an inlet for supplying the feed material to the reaction chamber, an assembly for moving the feed material through the reaction chamber from the upstream end towards the downstream end of the chamber counter-current to the flow of gas generated in the chamber as a consequence of drying or other reactions in the chamber, and separate outlets for the solid carbon-containing product, the gas product, and optionally an oil product and a separate water-based condensate product from the reaction chamber, with the apparatus being adapted to decompose organic material contaminants in the wood wastes and to incorporate the decomposed forms into useful products, and with the apparatus being adapted to deport heavy metal contaminants to the solid carbon-containing product.

In broad terms, the present invention also provides a method for processing wood wastes and producing valuable products that are safe and have economic value in the apparatus described in the preceding paragraph, with the method including the steps of:
(a) supplying a solid feed material that includes wood wastes containing contaminants to the inlet of the reaction chamber of the apparatus;
(b) moving the feed material through the reaction chamber from the inlet to the downstream end of the chamber and exposing the feed material to a time-temperature profile within the chamber that dries and pyrolyses or otherwise processes the feed material and releases water vapour and a volatile products gas phase from the feed material as the feed material moves through the chamber;
(c) moving the water vapour phase and the volatile products gas phase produced by heating the feed material in step (b) through the reaction chamber in a direction counter to that of the feed material so that at least a part of the water vapour phase and the condensable components of the volatile products gas phase condense in cooler upstream sections of the reaction chamber and form liquid water and liquid oil, at least the liquid oil being carried forward in the reaction chamber by the feed material to the higher temperature regions of the reaction chamber and being progressively volatilised and cracked to a non-condensable gas; and
(d) discharging (i) a gas product and (ii) a dried and pyrolysed solid carbon-containing product from the separate outlets of the chamber, and
   with the time-temperature profile within the chamber ensuring that (i) organic material contaminants in the wood wastes are decomposed and the decomposed forms are incorporated into useful products and (ii) heavy metal contaminants in the wood wastes are deported to the solid carbon-containing product.

The wood wastes may be any suitable wood wastes having regard to the process requirements.

One requirement for the wood wastes is to ensure the packed bed of feed material has a structure that maintains the required characteristics of the packed bed as it moves through the reaction chamber of the converter. By way of example, the structure may be to provide the packed bed with sufficient porosity for gas flow counter-current to the direction of movement of the moving bed of feed material through the reaction chamber.

Typically, the wood wastes are in a particulate form.

The wood wastes may be in a particulate form having a particle size of minus 25 mm, typically minus 20 mm.

Less than 15 wt. %, typically less than 10 wt. %, of the total mass of wastes may have a particle size of minus 1 mm. This is regarded as a fines component of the feed material.

Typically, the amount of moisture in the feed material is less than 20 wt. %, more typically less than 15 wt. %, of the total mass of the feed material. There may be situations where there are higher moisture contents.

Typically, the gas product includes water vapour and non-condensable gases including carbon monoxide, carbon dioxide, hydrogen, and hydrocarbons (particularly methane).

The method may include controlling gas product composition having regard to end-use requirements for the gas product.

The gas product may contain varying amounts of hydrogen and methane. There may be situations in which higher concentrations of hydrogen and lower concentrations of methane are preferred. There may be other situations, for example when the gas product is used for electricity generation in an internal combustion engine, where higher concentrations of methane and lower concentrations of hydrogen are preferred.

The method may include controlling the gas product composition by controlling the temperature profile in the reactor and therefore the residence time within a required temperature range.

The method may include draining some liquid oil form the chamber as a separate product.

As described above, the method may be operated so that water is discharged as water vapour only and there is no liquid water discharged from the chamber. Consequently, the only “products” discharged from the chamber are a gas product and a solid carbon-containing product. The gas product may include water vapour, CO, H₂, CO₂, N₂, methane, ethane and other light hydrocarbons.

The method may include condensing water vapour from the gas product outside the chamber and forming a liquid water product. The remaining gas product may be used as a fuel gas.

However, it is also noted that the method may include forming a water-based condensate product within the chamber and discharging the product from the chamber.

The method may be operated at a small negative pressure relative to atmospheric pressure at the upstream feed material end of the reaction chamber to prevent or minimise the risk of gas leakage from the reaction chamber.

The method may include supplying water to the downstream end of the reaction chamber to control solid carbon-containing product characteristics such as moisture content. For example, higher moisture contents may be desirable for solid carbon-containing products for agricultural use. Lower moisture contents may be suitable for industrial applications, such as char (e.g. for metallurgy and power generation) where water needs to be limited). Adding water helps to overcome problems associated with potentially pyrohorric char (spontaneous combustion).

The temperature profile in the reaction chamber is an important consideration. Operating with a required temperature profile requires selecting appropriate operating conditions, including feed rate along the length of the reaction chamber and air injection rate into the chamber, having regard to the composition and physical characteristics of the feed materials and the need for balancing internal heating, process heat and heat losses

Typically, the required temperature profile is an extended temperature gradient in a countercurrent solids/gas reactor. The term “extended” in this context means that sufficient time is allowed for the required reactions to occur in the reaction chamber. As is discussed further below, the applicant has realised that appropriate processing of feed materials requires the material to move through three zones involving drying, heating and thermo-chemical reactions and it is necessary to allow sufficient time for these process steps to be achieved.

The method may include maintaining a required temperature profile in the reaction chamber by supplying an oxygen-containing gas, such as air, to the reaction chamber and at least partially combusting combustible gases in the reaction chamber. The combustible gases may be generated by pyrolysis of organic material in the reaction chamber.

The temperature profile in the reaction chamber may include a plurality of zones successively along the length of the chamber in which different reactions occur as the feed material moves from the upstream cooler end to the downstream hotter end of the reaction chamber.

The continuous converter may include an assembly for establishing a temperature profile in the reaction chamber that includes the following zones extending successively along the length of the reaction chamber from the upstream end to the downstream end of the reaction chamber:
(a) a drying zone (Zone 1) for drying the feed material—typically 60-80° C. is the inlet end temperature and 100-150° C. is the upper temperature limit of Zone 1,
(b) a pre-heating zone (Zone 2) for heating the feed material to a temperature that is suitable for the thermo-chemical reactions required in the next zone—typically 250-300° C. is the upper limit of Zone 2, and
(c) a thermo-chemical reaction zone (Zone 3) for thermally decomposing the feed material and producing a solid carbon-containing, typically char product, and gas.

Thermal decomposition of the feed material in Zone 3 devolatilises the feed material and generates gas. The gas includes some combustible gas and this combustible gas combusts in Zone 3 and generates heat within the zone. Typically, 600-650° C. is the upper limit of Zone 3.

The applicant has found that the thermal decomposition reactions are predominantly endothermic and the combustion of some of the combustible gas released from the feed material is important to maintain reaction temperatures in Zone 3.

The gas generated in Zone 3 inevitably moves from the hotter downstream end to the colder upstream end of the chamber because the downstream end has a gas seal and there is a gas outlet in the upstream end of the chamber. There is convective heat transfer to the feed material in Zones 1 and 2 from the comparatively hot gas moving from Zone 3 towards the colder upstream end of the reactor counter-current to the direction of movement of the feed material successively through the zones.

The method may include supplying the oxygen-containing gas, such as air, to the reaction chamber in Zone 3, whereby the devolatilization produces combustible gases that are combusted by the oxygen-containing gas. Supplying the oxygen-containing gas in this region of the reaction chamber optimises the combustion of combustible gases to where it is most beneficial.

The oxygen-containing gas may be oxygen, air, or oxygen-enriched air.

In broad terms, the present invention also provides an apparatus for processing wood wastes and producing valuable products that are safe and have economic value, with the apparatus including the apparatus described above.

In broad terms, the present invention also provides a method for processing wood wastes and producing valuable products that are safe and have economic value including the steps of:
(a) size reduction wood wastes;
(b) reducing the water content of the wood wastes to a predetermined content; and
(c) processing the wood wastes in the above-described method and producing valuable products

Step (b) of reducing the water content of the wood wastes may include a drying step after the de-watering step.

### BRIEF DESCRIPTION OF THE DRAWINGS

The present invention is described further by way of example only with reference to the accompanying drawings, of which:

FIG. 1 is a diagram that illustrates one embodiment of a method and an apparatus for processing wood wastes and producing valuable products that are safe and have economic value in accordance with the present invention;

FIG. 2 is a temperature/time profile in the reaction chamber of a continuous converter for carrying out the method illustrated in FIG. 1, with the profile being generated from trial data described below;

FIG. 3 is a perspective view of one embodiment of an apparatus in the form of a continuous converter in accordance with the invention;

FIG. 4 is a transverse cross-section through the continuous converter along the line 5-5 shown in FIG. 4

FIG. 5 is a temperature-time graph at a series of locations along the length of a reactor for a trial with a feed material comprising 100 wt. % wood waste feed material in trials of an embodiment of the method and the apparatus of the invention, with the graph illustrating a 1 hour period of the trial; and

FIG. 6 is a temperature-time graph at a series of locations along the length of a reactor for a trial with a feed material comprising contaminated wood waste including 7 wt. % plastics material in trials of the embodiment of the method and the apparatus of the invention mentioned in the description of FIG. 5, with the graph illustrating a 1 hour period of the trial.

### DESCRIPTION OF EMBODIMENTS

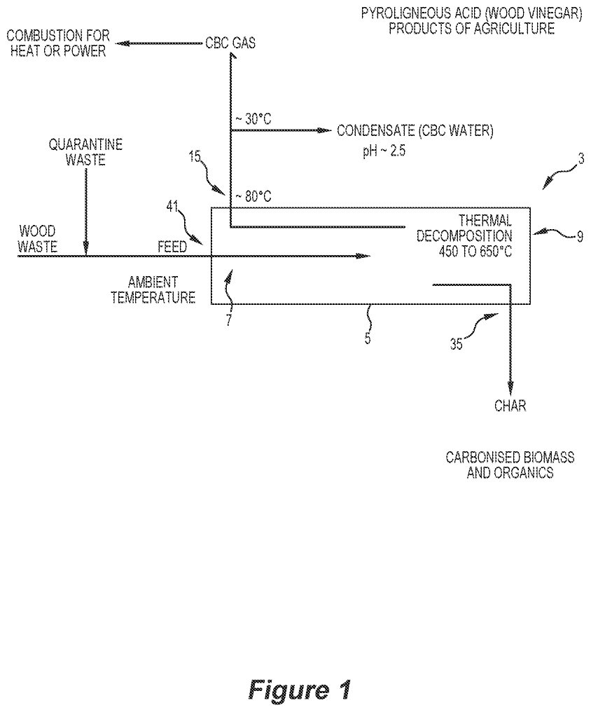

FIG. 1 is a diagram that illustrates one embodiment of a method and apparatus for processing wood wastes and producing valuable products that are safe and have economic value in accordance with the invention.

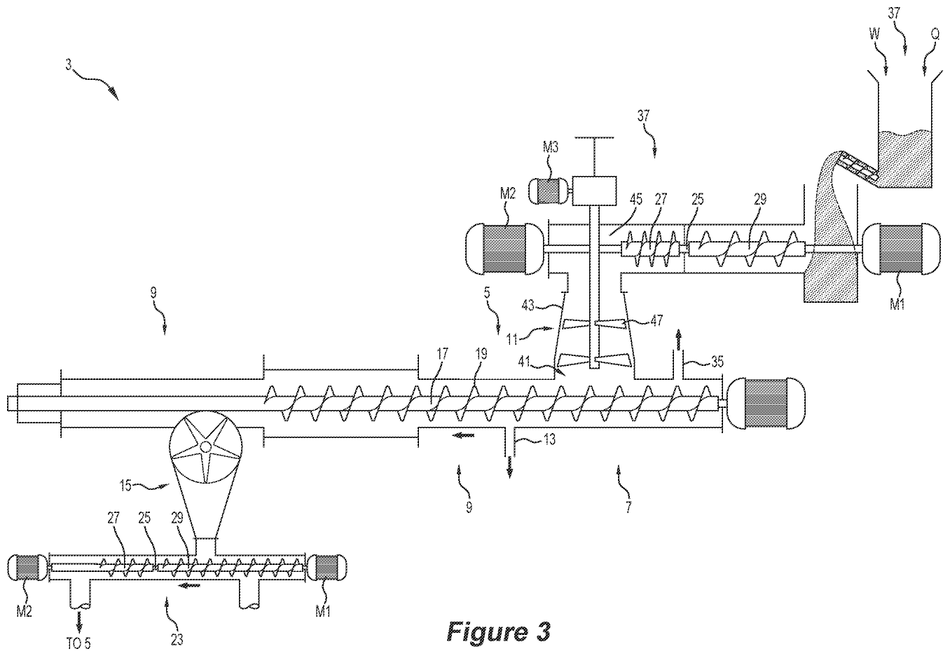

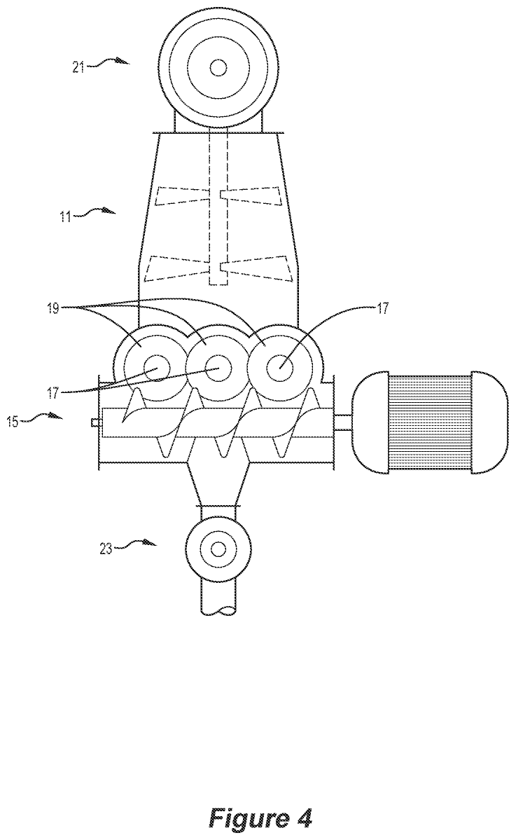

With reference to FIG. 1, feed material in the form of wood waste containing contaminants is supplied at ambient temperature to an inlet of a reaction chamber 5 of continuous converter 3 shown diagrammatically in FIG. 1 and in more detail in FIGS. 3 and 4 and also described in International applications PCT/AU2009/000455 (WO2009/124359) and PCT/AU2014/001020 (WO2015/061833) in the name of the applicant.

The feed material is moved through the reaction chamber 5 from an inlet 41 at an upstream end 7 to a downstream end 9 of the chamber and is exposed to a temperature profile that reaches a maximum of 650° C. over a selected time period within the chamber 5 that:
(a) pyrolyses organic material in the feed material,
(b) releases water vapour and a volatile products gas phase,
(c) decomposes organic material contaminants and incorporates decomposed products into useful products effectively, and
(d) deports at least a significant proportion of heavy metal contaminants in these wood wastes to a char product, with the char product being a preferable medium for the heavy metals than the liquid and gas products, and with the heavy metals being recoverable from the char product if the levels are sufficiently high to warrant recovery.

The water vapour phase and the volatile products gas phase produced by heating the feed material moves in a direction counter to that of the feed material. At least a part of the water vapour phase and the condensable components of the volatile products gas phase condense in cooler upstream sections of the chamber and form liquid water and liquid oil/tars. At least the liquid oil/tars is carried forward in the reaction chamber by the feed material to the higher temperature regions of the reaction chamber and is progressively volatilised and cracked to a non-condensable gas. In some circumstances, liquid oil may be drained from the reactor 5 as a product.

A gas product and a dried and pyrolysed solid carbon-containing product are discharged from separate respective outlets 15, 35 in the reaction chamber 5.

The temperature profile in the reaction chamber 5 is selected and controlled so that the gas product discharged from the reaction chamber 5 is at a temperature of the order of 80° C. The gas product is transported away from the reaction chamber 5 and the water vapour phase and condensable components of the volatile products gas phase condense in cooler upstream sections at a temperature of the order of 30° C. and form (a) a water-based condensate product (water recovered from a pyrolysis process is typically somewhat acidic and contains dilute smoke chemicals and other organics; it is often referred to as pyroligneous acid or “wood vinegar” and has beneficial applications in horticulture) and (b) a separate fuel gas product that has sufficient calorific value to be combusted as an energy source.

The contaminants in wood wastes may be as described above. The contaminants may include organic materials such as resins, glues, paints etc. that make it difficult to cost-effectively process the wood wastes for use as or in new products. The contaminants may also include heavy metals.

The solid char, gas and water-based condensate product outputs are intrinsically valuable, with a wide range of potential material and energy applications in industry and agriculture.

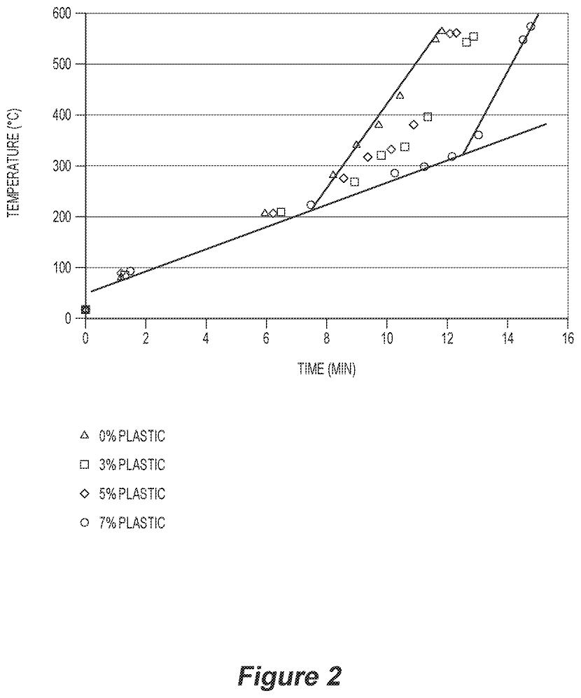

Embodiments of suitable temperature profile in the reaction chamber are shown in FIG. 2.

FIG. 2 was generated from trial data described in more detail below.

The horizontal axis of FIG. 2 is time that a unit of feed material has been in the reaction chamber 5 measured in minutes and the vertical axis of the Figure is temperature in ° C. Time is a measure of position along the length of the reaction chamber 5.

FIG. 2 shows the results of trials with 4 different feed materials, with the feed materials of each trial comprising wood wastes and different amounts of plastics material.

FIG. 2 shows that the temperature of the feed material in each trial increased steadily to approximately 250° C. after 8 minutes within the reaction chamber 5.

FIG. 2 also shows that the temperature of the feed material having 100 wt. % wood wastes then increased quickly generally linearly during the next 4 minutes to 600° C. This sharp increase indicates thermo-chemical reactions of the feed material, i.e. Zone 3 of the temperature profile described above.

FIG. 2 also shows similar sharp increases in temperature at later start times for feed materials having increasing proportions of plastics materials, with the start times being a function of the increasing proportions of plastics materials in the feed materials. Basically, the steady heating of the feed materials continued along the lower gradient line shown in the Figure until the temperature reached a point where significant thermo-chemical reactions commenced and there was a sharp increase in temperature.

It is evident from FIG. 2 that the 4 feed materials had the same basic temperature-time profiles, with the only differences being the temperature and time at which the increased heating rate commenced.

Basically, FIG. 2 shows an extended temperature-time gradient in a countercurrent solids/gas reactor. The trial results described below establish that the extended temperature-time gradient shown in FIG. 2 make it possible to process wood wastes as the only feed material and wood wastes with other components, in the present instance plastics materials, in the feed material.

FIG. 2 illustrates that the temperature profile in the reaction chamber includes the following zones extending successively along the length of the reaction chamber from the upstream end to the downstream end of the reaction chamber:
(a) a drying zone (Zone 1) for drying the feed material—typically increasing from 60-80° C. at the inlet to 100-150° C. at the upper temperature limit of Zone 1,
(b) a pre-heating zone (Zone 2) for heating the feed material to a temperature that is suitable for the thermo-chemical reactions required in the Zone 3−typically 250-300° C. is the upper limit of Zone 2, and
(c) a thermo-chemical reaction Zone 3 for thermally decomposing the feed material and producing a solid carbon-containing, typically char product, and gas.

With reference to FIGS. 3 and 4, the embodiment of the apparatus in the form of a continuous converter, generally identified by the numeral 3, for decomposing organic contaminants in wood wastes shown in the Figures includes a reaction chamber 5 that has an upstream colder end 7, an inlet 41 for feed material (including waste wood containing contaminants), a downstream hotter end 9, outlets 13, 35 for discharging liquid water and gas products respectively from the chamber 5 at the upstream end, and an outlet 15 for discharging a solid carbon-containing product, for example in the form of char, at the downstream end of the chamber 5.

The converter 3 also comprises a feed hopper 37 for suppling organic feed material to the upstream end of the reaction chamber. The feed hopper may be a sealed or an open hopper.

The converter 3 also comprises an assembly that forces feed material continuously forwardly in the reaction chamber 5 from the upstream end 7 towards the downstream end 9. The assembly comprises three parallel rotatable shafts 17 and screw feeders 19 on the shaft. The screw feeders 19 are interleaved. One shaft 19 is a motor-driven shaft via motor M4 and the other shafts 19 are linked to rotate with the driven shaft. This is a simple and reliable arrangement whereby rotation of the shafts 17 about their axes forces feed material from the upstream end towards the downstream end of the chamber 5. The feed screw arrangement can include a single or any other suitable number of multiple screws, which may or may not be interleaved.

The converter 3 also includes an intruder 21 (i.e. a gas-sealed entry device) for supplying feed material to the reaction chamber 5 and an extruder 23 (i.e. a gas-sealed discharge device) for discharging the solid carbon-containing product from the chamber 5. Each device includes two screws 27, 29 on the same axis. The screws 27, 29 are mounted to counter-rotate with respect to each other about the axis. It is noted that the screws 27, 29, may be arranged to rotate in the same direction. The screws are separated by an axial gap 25. The intruder 21 controls the rate of supplying feed material to the reaction chamber 5 and compresses feed material and forms a seal that minimises escape of gas from the chamber 5 via the intruder. Each screw 27, 29 is independently driven by a motor M1, M2 with variable speed capability so that in use the downstream screw 27 runs at a slower rotation rate than the upstream screw 29. The difference in the rates of rotation causes feed material supplied to the upstream screw 29 from the feed hopper 37 and transported to the gap 25 to be compressed in the gap 25 and to enter the downstream screw 27 as compressed material and to travel forward as compressed material via the downstream screw 27.

The method and the seal quality may be controlled by setting the motor torque of the motors M1 and M2 to a level determined to be required to deliver a required level of compression. Typically, motor torque and not rate of rotation is set for control purposes. Typically, the rate of rotation of the upstream screw 29 is linked directly to the rate of rotation of the motor-driven screw feeder 19 in the reaction chamber 5 to control throughput. Typically, the rate of rotation of the downstream screw 27 is controlled to maintain constant torque of the upstream screw 29 of the intruder 21 to control compression. The packing density of the feed material to achieve a required seal may be dependent on a number of factors, including the characteristics of the feed material. The characteristics may include the packing characteristics of the feed material.

It is noted that the opposite arrangement may be used for control purposes. Specifically, the rate of rotation of the downstream screw 27 may be linked directly to the rate of rotation of the motor-driven screw feeder 19 in the reaction chamber 5 to control throughput and the rate of rotation of the upstream screw 29 may be controlled to maintain constant torque of the downstream screw 27 of the intruder 21 to control compression.

Similarly, the extruder 23 controls the rate of discharging solid carbon-containing product from the reaction chamber 5 and forms a seal that prevents escape of gas from the reaction chamber 5 via the extruder 23. The intruder 21 and the extruder 23 have the same basic structural components and these are identified by the same reference numerals in the Figures.

The converter 3 also includes a feed assembly generally identified by the numeral 11 for controlling the flow of feed material from the intruder 21 to the inlet 41 of the reaction chamber 5. The feed assembly 11 includes a transfer chute that is in the form of a distribution box 43 between an outlet 45 of the intruder 21 and the inlet 41 of the reaction chamber 5 and a sweeper blade 47 that is rotatable about a central vertical axis of the distribution box 43 via operation of a motor M3 to control the distribution of feed material to the reaction chamber inlet 41.

In use, feed material from the outlet 45 of the intruder 21 falls downwardly through the inlet 41 into an upstream end of the reaction chamber 5 and is moved forward, for example by means of an auger in the reaction chamber, through the reaction chamber 5 and is thermally decomposed and then discharged as a solid carbon-containing product from the chamber 5 via the extruder 23, with liquid water and gas products also being produced and discharges from the chamber 5 via the outlets 13, 35 as the feed material moves through the chamber 5.

Typically, the feed rate to the reaction chamber 5 is controlled to ensure that the chamber is full of feed material.

The sweeper blade 47 is important to ensuring that there is a uniform distribution of feed material delivered to the inlet of the reaction chamber 5, i.e. so that the reaction chamber 5 is full of feed material.

The level of feed material in the distribution box 43 is also an important consideration from an operational viewpoint. The applicant has found that the apparatus may block if the level of feed material is too high.

The method of operating the converter 3 includes measuring the torque on the sweeper blade 47 to provide an indication of the level of feed material in the distribution box and adjusting the rate of rotation of the upstream screw of the intruder 21 to control the supply rate of feed material to maintain the desired level of feed material in the distribution box 43.

The converter 3 has structural features that make it possible to establish and maintain a required temperature profile in the reaction chamber 5 to operate one embodiment of the method of the present invention in the reaction chamber 5.

In particular, important features of the converter 3 include, for example, selection of the length of the reaction chamber 5, selection of the feed (e.g. biomass) and the feed rate (i.e. organic material) through the chamber 5, providing targeted injection of oxygen-containing gas into the chamber 5, providing targeted injection of liquid water into a downstream end of the chamber 5 for char cooling, and providing a means for achieving internal heat transfer within the chamber.

The converter 3 is particularly suited for a method that operates so that there is total destruction of the liquid oil product produced in the chamber. Specifically, the method is operated so that there is volatilization and cracking of liquid oil and tar product that forms in the chamber to the extent that there is total destruction of the liquid oil and tar product into a non-condensable gas that is discharged from the upstream end of the chamber. Having said this, there may be situations in which it is desirable to drain some oil from the chamber 5 as a separate product.

The method and the apparatus of the present invention create a completely unique thermo-chemical environment compared to known pyrolysis technologies that are commercially available or under development.

### Experimental Work—Trials

As described above, the applicant has identified operating conditions that make the continuous biomass converter technology particularly effective for processing wood wastes containing contaminants and producing valuable products that are safe and have economic value.

### A. Trials on Wood Wastes—Engineered Timbers

The applicant has carried out a series of trials on wood wastes in the form of engineered timbers provided by Laminex Group.

The applicant found that organic material contaminants in these wood wastes and contaminants in pyrethroid-impregnated timbers such as H2-F Blue Pine waste can be decomposed altogether or converted into useful products effectively by the continuous biomass converter technology of the applicant.

In addition, the applicant found that heavy metal contaminants in these wood wastes deported to the char product of the converter.

### 1. Engineered Timbers

The Laminex wood wastes were in the form of engineered timber wastes.

Specifically, the wood wastes comprised particle board (PB), medium density fibreboard (MDF) and plywood timber products. MDF is manufactured from softwood fibres, wax and resin. Wax is used to improve the moisture resistance of the finished product while urea formaldehyde resin bonds the fibres together in the finished pressed board. PB is manufactured in a similar process but uses wood particles rather than fibres.

Table 1 provides an approximate composition profile of the PB, MDF and plywood products.

TABLE 1
Approximate composition of PB, MDF and Plywood

### 1.1 Chemical Properties

Engineered timber product waste sample analysis (other than the analyses for plywood samples) was undertaken by NATA accredited LabMark Environmental Laboratories (NATA Acc. Site No. 18217, Accreditation No. 1261) using samples collected in accordance with a sampling plan. Fluorine and chlorine testing was subcontracted to Amdel Ltd (NATA accreditation No. 626), while melamine and cyanuric acid was analysed by AsureQuality.

Plywood waste sample analysis was undertaken by NATA accredited Eurofins Environmental Testing Australia [formerly LabMark] (NATA Acc. Site No. 14271, Accreditation No. 1261) using samples collected in accordance with a sampling plan. Fluorine and chlorine testing was subcontracted to Amdel Ltd (NATA accreditation No. 626), while melamine and cyanuric acid was analysed by AsureQuality.

The samples were tested for calorific value for the application for use of the engineered timber product waste as non-standard fuel. Calorific value testing was carried out by SGS Australia Pty Ltd (NATA Accreditation No. 2562).

The number of samples taken of each type of engineered timber product was determined by the

proportion of product sold; i.e. 82% of the product sold is decorated whilst 18% is raw product.

A summary of the results of laboratory analysis are presented in Table 2 along with guideline values for chemical properties established by the NSW EPA. Where NSW EPA guidance was not available, the Swiss Agency for the Environment, Forests and Landscape (SAEFL) National Environment Protection Guideline on Investigation Levels for Soil and Groundwaters—Guidelines: Disposal of Wastes in Cement Plants was referenced.

TABLE 2
Summary Chemical Characterisation of Engineered
Timber Product Waste

| Chemical | | | Levels for | | | | Standard |
|---|---|---|---|---|---|---|---|
| Attributes | Units | LOR | Characterisation | Minimum | Maximum | Average | Deviation |
| % Moisture | % | 0.1 | | 3.7 | 9.3 | 6.9 | 1.2 |
| Ash | % w/w | 0.01 | | 0.2 | 10.0 | 4.1 | 3.0 |
| Calorific Value | Kcal/kg | | | 4.026 | 4.682 | 4.312 | 143 |
| Conductivity (1:5 | dS/cm | 0.005 | | 0.1 | 0.7 | 0.3 | 0.1 |
| aqueous extract) | | | | | | | |
| Formaldehyde | mg/kg | 10 | | 190 | 53.000 | 19.772 | 11.333 |
| Loss on Ignition | % | 0.1 | | 95 | 100 | 99 | 1.2 |
| (550° C.) | | | | | | | |
| Melamine | mg/kg | 1.0 | | 4.4 | 660 | 134 | 136 |
| Nitrate & Nitrite | mg/kg | 0.1 | | 0.3 | 18.0 | 5.1 | 4.5 |
| (N) | | | | | | | |
| pH (1:5 Aqueous | units | 0.1 | 8-11¹ | 4.6 | 8.6 | 5.6 | 1.0 |
| extract) | | | | | | | |
| Phosphorus | mg/kg | 10 | | 5 | 250 | 76 | 57 |
| Sulphur | mg/kg | 100 | 5000¹ | 38 | 770 | 198 | 203 |
| Total Chlorine | % | 0.01 | | 0.0 | 0.1 | 0.0 | 0.0 |
| Total Fluorine | mg/kg | 20 | | 10 | 10 | 10 | 0.0 |
| Total Kjeldahl | mg/kg | 10 | | 1.000 | 63.000 | 33.876 | 16.647 |
| Nitrogen (N) | | | | | | | |
| Total Nitrogen | mg/kg | 10 | | 1.000 | 63.000 | 33.894 | 16.664 |
| (N) | | | | | | | |
| Total Oxidisable | % | 0.5 | | 7.3 | 78.0 | 38.9 | 20.6 |
| Organic Carbon | | | | | | | |
| Heavy Metals | | | | | | | |
| Antimony | mg/kg | 1 | 3 · 6² | 0.1 | 5.0 | 0.5 | 1.5 |
| Arsenic | mg/kg | 1 | 10¹ · 11² | 0.1 | 3.6 | 0.3 | 0.6 |
| Beryllium | mg/kg | 1 | 3 · 6² | 0.1 | 1.0 | 0.1 | 0.3 |
| Boron | mg/kg | 5 | | 2.5 | 24.0 | 5.9 | 5.8 |
| Cadmium | mg/kg | 0.1 | 0.5¹ · 1.4² | 0.1 | 0.2 | 0.1 | 0.0 |
| Chromium | mg/kg | 2 | 75¹ · 72² | 1.0 | 8.5 | 3.0 | 1.1 |
| Cobalt | mg/kg | 1 | 14² | 0.1 | 2.5 | 0.3 | 0.7 |
| Copper | mg/kg | 2 | 50¹ · 72² | 1.0 | 27.0 | 2.2 | 3.6 |
| Lead | mg/kg | 2 | 50¹ · 145² | 1.0 | 4.4 | 1.2 | 0.7 |
| Manganese | mg/kg | 5 | | 6.3 | 56.0 | 23.2 | 11.6 |
| Mercury | mg/kg | 0.05 | 0.5¹ · 0.36² | 0.0 | 0.2 | 0.1 | 0.1 |
| Molybdenum | mg/kg | 1 | | 0.5 | 5.0 | 0.9 | 1.3 |
| Nickel | mg/kg | 1 | 40¹ · 72² | 0.5 | 2.5 | 0.8 | 0.7 |
| Selenium | mg/kg | 2 | 2¹ · 3.6² | 1.0 | 2.5 | 1.1 | 0.4 |
| Tin | mg/kg | 1 | 7 · 1² | 0.5 | 5.0 | 0.9 | 1.3 |
| Vanadium | mg/kg | 5 | 72² | 2.5 | 5.0 | 2.7 | 0.7 |
| Zinc | mg/kg | 5 | 100¹ · 290² | 2.5 | 14.0 | 3.5 | 2.4 |
| Speciated | | | | | | | |
| Phenols | | | | | | | |
| 2.4.5- | mg/kg | 0.5 | | 0.5 | 1.3 | 1.2 | 0.2 |
| Trichlorophenol | | | | | | | |
| 2.4.6- | mg/kg | 0.5 | | 0.5 | 1.3 | 1.2 | 0.2 |
| Trichlorophenol | | | | | | | |
| 2.4- | mg/kg | 0.5 | | 0.3 | 1.3 | 1.2 | 0.3 |
| Dichlorophenol | | | | | | | |
| 2.4- | mg/kg | 0.5 | | 0.3 | 8.8 | 1.4 | 1.2 |
| Dimethylphenol | | | | | | | |
| 2-Chlorophenol | mg/kg | 0.5 | | 0.3 | 1.3 | 1.2 | 0.3 |
| 2-Methylphenol | mg/kg | 0.5 | | 0.1 | 19.0 | 1.7 | 2.9 |
| (o-Cresol) | | | | | | | |
| 2-Nitrophenol | mg/kg | 0.5 | | 0.5 | 3.6 | 1.2 | 0.4 |
| 3&4- | mg/kg | 1 | | 0.2 | 25.0 | 3.0 | 3.7 |
| Methylphenol | | | | | | | |
| (m&p-Cresol) | | | | | | | |
| 4-Chloro-3- | mg/kg | 0.5 | | 0.5 | 28.0 | 1.7 | 3.7 |
| methylphenol | | | | | | | |
| Pentachlorophenol | mg/kg | 1 | | 0.5 | 2.5 | 2.3 | 0.6 |
| Phenol | mg/kg | 0.5 | 8500² | 0.3 | 3.700 | 129.9 | 622.8 |
| Phenol-d5 (surr.) | % | 1 | | 71.0 | 104.0 | 92.1 | 5.9 |

Note:
Where samples resulted in less than the LOR, or where the attribute was not detected (ND), 0.5 × LOR was used to calculate averages, minimum, maximum and SD.
¹General Exemption under Part 9, Clause 93 Protection of the Environment Operations (Waste) Regulation (2014) - The coal washery rejects order 2014, Table 1. p.3.
²SAEFL. (2005). Guidelines: Disposal of Wastes in Cement Plants. Swiss Agency for the Environment, Forests and Landscape.

Formaldehyde levels for the samples ranged between 2000 mg/kg for sample #7 (HPL) to 53,000 mg/kg for sample #44 (Raw MDF). Similarly, melamine levels for the samples ranged between 5.5 in sample #41 (raw MDF) to 660 in sample #32 (raw PB). These substances when heated can produce a suite of volatile organic compounds. However, the chemical analysis of the samples must be viewed within the context of the proposed utilisation of the engineered timber product waste as a feedstock for the continuous biomass converter technology.

As a consequence of decomposition, tar cracking and scrubbing actions within the reactor, the continuous converter produces a gas essentially free of higher molecular weight compounds.

### 2. Treated Timbers—H2-F Blue Pine Waste—Pyrethroid-Impregnated Timber

### 2.1 Chemical Properties

Plantation pine is considered an eligible fuel and not subject to any environmentally based regulatory controls.

Addition of up to 0.02% pyrethroid (as either 0.02% permethrin, using a natural oil as the delivery vector, or 0.02% bifenthrin, using water as the delivery vector in framing timber) or 0.0078% nicotinoid (as imidacloprid) (AS1604.1-2012) is an entirely known and understood process not requiring full chemical analysis in order to characterise the waste/offcuts. The AS 1604.1-2012 Specification for preservative treatment: Sawn and round timber standard specifies the minimum concentrations of the oven-dried active ingredients utilised for the production of H2-F blue pine framing timbers.

The concentration of the active organo-chlorine ingredients is of the order of tens and hundreds of parts per million (i.e. 0.02% w/w=200 ppm). Given the concentrates/starting solutions of bifenthrin, permethrin and imidacloprid have a high concentration of the active ingredients, the dilution effect during the preparation and impregnation of pine timber is in the order of 1,000 times or more.

3. Initial Trial with Engineered Timbers

A preliminary trial was carried out to monitor emissions at the flare, especially VOC's and aldehydes as an indication of the ability of the continuous converter to break down complex organic constituents of engineered timbers.

### 3.1 Gas Properties/Air Emissions

Emissions from combustion of the continuous converter gas at the flare were measured by ETC (now Ektimo) and are summarised in Table 3.

Clean timber was used as a reference feedstock; and the trial feedstock was a blend of 50% clean timber and 50% decorated particle board, referred to as the “Laminex Blend”.

TABLE 3
Air Quality - Flare Combustion of Gas Product

| | | | | Laminex |
|---|---|---|---|---|
| | Detection | Group 6 | Clean Timber | Blend |
| | Limit ¹⁶ | Standards¹⁷ | Emissions ¹⁸ | Emissions |
| Substance | (mg/m³) | (mg/m³) | (mg/m³) | (mg/m³) |
| Particulates | <4.0 | 50 | <4.0 | 5.1 |
| VOC's | | 40 | 4.0 and 6.1 | 10 |
| Formaldehyde | <0.1 | | <0.1 | <0.1 |
| Acetaldehyde | <0.1 | | <0.1 | <0.1 |
| NOₓ | | 450 | 240 and 450 | 1.500 |

All units are mg/m³ at NTP and 3% O₂

This trial was considered to have a positive outcome. The following important facts/findings are noted from this trial with respect to the gas product:
VOC emissions well below Group 6 (Clean Air Regulation) standards, consistent with the proposition that complex, long chain molecules do not endure the particular thermochemical conditions of the continuous biomass converter technology.
Formaldehyde and acetaldehyde emissions were below detection limits. Note the detection limit of 0.1 mg/Nm³ at the flare would be triggered by as little as 350 mg of aldehydes if emitted from one tonne of engineered timber feedstock, i.e. 0.35 ppm emitted from the feedstock. The formaldehyde content of engineered timbers is many orders of magnitude higher than this, with formaldehyde ranging from 900 to 53,000 ppm. The fact that aldehydes were not detectable in the emissions is therefore considered positive evidence that continuous converter processing of engineered timbers does not release aldehydes to air.
Particulates were found to be well below Group 6 standards, and were not significantly compromised by 50% engineered timber in the feed blend.
There was no visible smoke during the trial, which is typical of normal continuous converter operations.
SO₂ was monitored but was undetectable in the emissions for both the clean timber and the engineered timber blend. (Detection limit—6 mg/Nm³).

Concentrations of NOₓ were monitored at the flare and found to be rather variable during the trial. During two periods of clean timber processing, average NOₓ levels were 240 and 450 mg/Nm³, whereas they were higher at 1,500 mg/Nm³ during a period with the engineered timber blend. The extent to which NOₓ performance at the flare is dependent on fuel nitrogen (e.g. urea in the engineered timber) and/or burner design and combustion conditions has not yet been resolved. For perspective, NOₓ at 1,500 mg/Nm³ meets Group 5 standards, not Group 6 for Schedule 3 and 4. Note that the interim arrangement will be flaring where there are no NOₓ criteria.

### 3.2 Biochar Properties

Char samples were analysed from separate periods during the trial, covering the processing of clean timber and the 50% particle board blend (“Laminex blend”). The purpose of this preliminary trial was to compare and contrast the two chars against the following criteria:
Type 1 and Type 2 trace metals not to exceed 350 mg/kg;
Calorific value to be determined; and
Chlorine, fluorine, copper and sulphur to be recorded.

The results are summarised in Table 4.

TABLE 4
Summary of Char Assays

| | | Clean Timber | Laminex Blend |
|---|---|---|---|
| Properties | | Char (mg/kg)* | Char (mg/kg)* |
| Type 1 Metals | Antimony Sb | 0.3 | 0.9 |
| | Arsenic As | 0.3 | 1.4 |
| | Cadmium Cd | <0.01 | <0.01 |
| | Lead Pb | 0.9 | 5.1 |
| | Mercury Hg | 0.01 | 0.01 |
| | Total Type 1 | 1.5 | 7.4 |
| Type 2 Metals | Beryllium Be | 0.02 | 0.03 |
| | Chromium Cr | 25 | 31 |
| | Cobalt Co | 1.1 | 4.9 |
| | Maganese Mn | 47 | 73 |
| | Nickel Ni | 17 | 17 |
| | Selenium Se | 0.2 | 0.4 |
| | Tin Sn | 0.2 | 0.1 |
| | Vanadium V | 2 | 3 |
| | Total Type 2 | 92 | 130 |
| Type 1 and 2 Total | | 94 | 138 |
| Other Elements | Copper, Cu | 22 | 29 |
| | Sulphur, S % | 0.01 | 0.03 |
| | Chlorine, Cl % | 0.011 | <0.01 |
| | Fluorine, F | <10 | 11 |
| Calorific Value²³ | MJ/kg | 28.35 | 30.8 |

All results are reported in mg/kg on a dry weight basis except where otherwise noted. S and Cl concentrations are reported as % and the Calorific Value is reported in MJ/kg.

The following important facts/findings are noted from this trial with respect to the biochar:
The clean timber char and the engineered timber char have quite similar properties, with respect to trace elements and energy content.
Char quality as a fuel has not been compromised with the Laminex particle board added to the feedstock. In fact, carbonisation has progressed somewhat further with the engineered timber blend²⁴.
Both chars fall well below the Total Type 1 and 2 trace metal limit currently imposed on Delta's use of alternative fuels (350 ppm).
   4. Initial Trial with Pyrethroid-Impregnated Timbers—H2-F Blue Pine Waste

H2-F Blue Pine waste contains bifenthrin and permethrin. These are long chain complex chlorinated/fluorinated organic substances. A preliminary trial was therefore undertaken to test whether the continuous converter could break down under the thermo-chemical conditions inside the reactor, and that they would not act as precursors for dioxins, furans or PAH formation.

The initial trials relating to the H2-F treated blue pine framing timber. The shredded blue pine timber was 100% pre-consumer blue pine initially sourced from the timber and frame off-cuts of Bay Timber.

### 4.1 Gas Properties

It was decided to measure for the potentially toxic substances in the gas product of the continuous converter, before the flare, so that evidence of their presence could not be hidden by subsequent combustion. Gas concentrations were measured by ETC (now Ektimo), as summarised in the table below. The primary objective with regard to the gas product was to:
confirm bifenthrin and permethrin decomposition²⁸ under continuous biomass converter technology thermo-chemical conditions (expected above 250° C.; and
confirm that dioxin formation did not result from the decomposition of chlorinated organics (pyrethroids and nicotinoids).

The results of the fuel gas testing are reproduced in Table 5.

TABLE 5
Fuel Gas Composition - Prior to Flare Combustion
of Continuous biomass converter Technology Gas

| Substance | Units | CBC Gas |
|---|---|---|
| Bifenthrin | mg/Nm³ | <0.003 |
| Pemethrin | mg/Nm³ | <0.003 |
| Dioxins and Furans | ng/Nm³ TEQ | 0.019 |
| PAH | μg/Nm³ TEQ (BaP) | 17 |

The following facts/findings are noted from this trial and from the cumulative trials thus far with respect to the fuel gas:
The bifenthrin and permethrin were both below detection limits in the gas product. Note that the detection limit of 0.003 mg/Nm³ would be triggered if as little as 2.1 mg reported to the gas per one tonne of blue pine timber. In reality, the pyrethroid concentration in blue pine is orders of magnitude higher than this, typically around 0.02% or 200,000 mg per tonne of timber. This is therefore considered positive evidence that the bifenthrin and permethrin do not survive the thermo-chemical conditions of the continuous converter.
In this initial trial, dioxin and furan levels in the continuous biomass converter technology gas, before flaring, were measured at 0.019 ng/Nm³ TEQ, some five times below Group 6 emission standards. Actual flare emissions could be expected to be lower than this, given the dilution effect of the combustion air and possible destruction of dioxins and furans within the flare.
There are no published Group 6 emission limits for PAH's in NSW. The measured value in the gas product, before flaring, of 17 μg/Nm³ TEQ (BaP equivalent) corresponds to a BaP based emission factor of 12 μg/kg feedstock. Actual flare emission factors for the continuous converter may be lower, if there is any PAH destruction within the combustion zone. This initial result is in line with measurements reported in the literature for industrial stack emissions.

### 5. Initial Trial on Trace Metal Emissions

A feature of the continuous converter technology is, despite being a thermal process with an operating set point temperature of typically 650° C., the gas exits the reactor at low temperatures, typically around 80° C., followed by further cooling to lower the dew point of the gas and collect the water product of the continuous converter as a condensate. At these low gas exit temperatures, the vapour pressure of metals contained in the feed is very low.

A preliminary trial was therefore undertaken to test whether trace metal volatilisation from feedstocks to the product gas is not favoured under the thermo-chemical conditions of the reactor.

Metal concentrations were measured at the flare by Ektimo, as summarised in Table 6. The feedstock for the monitoring period was 40% clean timber, 40% H2-F blue pine, and 20% engineered timber waste.

TABLE 6
Flare Emissions Monitoring - Trace Metals

| | CBC Flare Emissions |
|---|---|
| Properties | (mg/Nm³ at 3% (O₂) |

| | | |
|---|---|---|
| Type 1 Metals | Antimony Sb | <0.002 |
| | Arsenic As | 0.018 |
| | Cadmium Cd | <0.001 |
| | Lead Pb | <0.002 |
| | Mercury Hg | 0.0021 |
| | Total Type 1 | 0.02 |
| Type 2 Metals | Beryllium Be | <0.001 |
| | Chromium Cr | 0.11 |
| | Cobalt Co | 0.0044 |
| | Manganese Mn | 0.014 |
| | Nickel Ni | 0.17 |
| | Selenium Se | 0.0037 |
| | Tin Sn | <0.002 |
| | Vanadium V | <0.001 |
| | Total Type 2 | 0.3 |
| Type 1 and 2 Total | | 0.33 |

The results confirm that a very small proportion of metals in the feedstock report to the gas. Importantly, for this feedstock blend, which included 40% clean timber, 40% Blue Pine and 20% engineered timber, heavy metal emissions are within Group 6 standards, namely Type 1 and 2 in aggregate below 1 mg/Nm³, and Hg and Cd individually below 0.2 mg/Nm³.

### 6. Comprehensive Trial—Blends of Pyrethroid-Impregnated Timbers Such as H2-F Blue Pine Waste and Engineered Timber

With positive indications coming from the initial continuous converter trials with feedstocks containing engineered timbers and H2-F blue pine, a comprehensive trial was conducted.

The important trial considerations/parameters include:
The core feedstock was a blend of 50% H2-F Blue Pine and 50% engineering timbers.
The prime focus was measuring emissions at the flare for the range of substances relevant waste gas concentrations to Group 6 (Clean Air Regulation) standards.
The trial also included a preceding period of 100% H2-F Blue Pine processing, with limited emissions monitoring.
The trial was subsequently followed by a run with 100% clean timber mill feedstock, but with no emissions monitoring.
The two supporting runs with blue pine and clean timber feedstocks were conducted primarily to obtain char and water samples for comparison with the char and water made from the 50:50 blend of blue pine and engineered timbers.

### 6.1 Air Emissions

Emissions at the flare were measured by Ektimo, as summarised in Table 7.

TABLE 7
Air Quality - Flare Combustion of Continuous
Biomass Converter Technology Gas

| | Group 6* | CBC 50:50 | CBC 100% |
|---|---|---|---|
| Pollutant/Species | Limit | Laminex:Blue | Blue Pine |
| Smoke | Ringleman 1 | Ringleman 0 | None |
| | 20% Opacity | None visible | Visible |
| Solid Particulates (Total) | 50 | <3 | |
| Type 1 and Type II | 1.0 | 0.027 | |
| Metals (in aggregate)^{c} | | | |
| Mercury | 0.2 | <0.002 | |
| Cadmium | 0.2 | <0.001 | |
| Dioxins or Furans | 0.1 | 0.00095 | |
| (ng/m³ TEQ) | | | |
| Volatile Organic | 40 | 0.02 | |
| Compounds (VOC's as | | | |
| n-propane) | | | |
| Sulfuric Acid Mist (SO₃ | 100 | 5.4 | 2.6 |
| equivalent) | | | |
| Hydrogen Sulfide (H₂S) | 5.0 | 0.46 | 8.1 |
| Fluorine (HF equivalent) | 50 | 3.2 | |
| Hydrogen Chloride (HCl) | 100 | 100 | 52 |
| Chlorine (Cl₂) | 200 | <0.02 | <0.02 |

All units are mg/rn³ at NTP and 3% O2, except for dioxins in ng/m³ at NTP and 3% O2.

For the suite of air quality parameters monitored in this trial, the results are very positive, in that all are well below Group 6 standards, except HCL (50:50 Laminex Blue) which was at the Group 6 limit and 1H₂S (100% Blue), which was above the Group 6 limit, although this result is questionable, since on the same day a value of 0.46 mg/rn³ with 50% blue was recorded.

For the same trial conditions, with the 50:50 Laminex: Blue Pine blend, a detailed breakdown of the trace metal emissions at the flare is given in Table 8.

TABLE 8
Flare Trace Metal Emissions

| Trace Metals | | CBC Flare |
|---|---|---|
| Type 1 | Antimony Sb | <0.001 |
| | Arsenic As | 0.011 |
| | Cadmium Cd | <0.001 |
| | Lead Pb | <0.001 |
| | Mercury Hg | <0.002 |
| | Total Type 1 | 0.011 |
| Type 2 | Beryllium Be | <0.001 |
| | Chromium Cr | <0.04 |
| | Cobalt Co | <0.001 |
| | Manganese Mn | <0.001 |
| | Nickel Ni | 0.0022 |
| | Selenium Se | 0.0095 |
| | Tin Sn | <0.001 |
| | Vanadium V | <0.001 |
| | Total Type 2 | 0.016 |
| Type 1 and 2 | Total | 0.27 |

All results reported in mg/Nm³ at 3% O₂

These results provide more evidence of the clean burning properties of the gas. The results are within Group 6 standards. Type 1 metals, other than Arsenic (0.011 mg/Nm³), and Type 2 trace metals, other than Nickel (0.0022 mg/Nm³) and Selenium (0.0095 mg/Nm³) were below detection.

### 6.2 Char Properties

The trial provided the opportunity to compare the properties of char samples manufactured from (1) the 50:50 Laminex:H2-F blue pine blend, as well as (2) 100% blue pine and (3) 100% clean timber for reference. The results are presented in Table 9 below.

TABLE 9
Continuous Biomass Converter Technology Char Properties

| | | Properties | | |
|---|---|---|---|---|
| | | Laminex Blue | Blue Pine | Clean Timber |
| | | 50:50 | 100% | 100% |
| | | Date of Manufacture (2015) | | |
| | | 7 January | 7 January | 15 January |
| Type 1 Metals | Antimony Sb | 0.2 | 0.2 | 0.1 |
| ppm | Arsenic As | 3.3 | 3.8 | 1.6 |
| dry basis | Cadmium Cd | 0.01 | 0.01 | 0.01 |
| | Lead Pb | 4 | 6 | 3 |
| | Mercury Hg | 0.01 | 0.01 | 0.01 |
| | Total Type 1 | 7.5 | 10 | 4.7 |
| Type 2 Metals | Beryllium Be | 0.17 | 0.23 | <0.01 |
| ppm | Chromium Cr | 33 | 49 | 20 |
| dry basis | Cobalt Co | 4.4 | 4.8 | 1.2 |
| | Manganese Mn | 156 | 182 | 67 |
| | Nickel Ni | 16 | 30 | 13 |
| | Selenium Se | 0.4 | 1.1 | 0.5 |
| | Tin Sn | 0.5 | 1.1 | 0.5 |
| | Vanadium V | 10 | 13 | 2 |
| | Total Type 2 | 190.5 | 241 | 105 |
| Type 1 and 2 | Total | 198 | 251 | 110 |
| Other Constituents | | | | |
| ppm dry basis | Copper. Cu | 23 | 24 | (46) |
| | Fluorine. F | 30 | 63 | (9) |
| % dry basis | Chlorine. Cl | 0.01 | 0.01 | (0.011) |
| | Nitrogen N | 2.64 | 0.3 | 0.41 |
| | Sulphur. S | 0.05 | 0.04 | (0.03) |
| | Ash ³⁷ | 17 | 30 | 4.6 |
| Fuel Related | Calorific Value | 31.8 | 31.9 | 31.5 |
| Properties | Volatile Matter | 24.7 | 26.9 | 25.6 |
| % dry ash free | Total Carbon | 83.2 | 85.2 | 82.4 |
| basis | Fixed Carbon | 75.3 | 73.1 | 74.4 |
| CV: MJ/kg | Hydrogen. H | 3.25 | 3.07 | 3.15 |

Results in brackets for clean timber are from an earlier char analysis made from the same source of clean timber³⁸

The following observations are noted from this trial with respect to the char:
From a fuel perspective, the two chars manufactured from waste wood feedstocks are essentially the same as the char made from clean timber, in terms of calorific value, volatile matter, and carbon and hydrogen contents.
The trace metal levels in the chars made from waste wood feedstocks are somewhat higher than the clean timber char; the differences are primarily driven by manganese
Nitrogen is significantly higher in the char made from the Laminex blend, presumably reflecting the higher nitrogen levels in the engineered timber feedstock (e.g. urea).

### 6.3 Water Product

The trial provided the opportunity to compare the properties of the water product manufactured from:
1. 50:50 Laminex:H2-F blue pine blend.
2. 100% blue pine.
3. 100% clean timber for reference.

The results are presented in Table 10.

The samples were taken from the continuous converter, without filtering or significant settling time; they can be regarded as ‘raw wood vinegar’.

The following observations are noted from this trial with respect to the water product:
The compositions of the three wood vinegars are similar, with no major differences apparent.
Comparing the clean timber wood vinegar with the wood vinegar made from the 50:50 Laminex; Blue blend, it has very similar Total Type1 and 2 trace metals (0.22 cf 0.27 ppm), slightly lower total hydrocarbons (0.57 cf 0.88%) and higher BTEXN (12.6 cf 4.4 ppm).
Trace metal levels are low, such that Type 1 and 2 in aggregate are less than 1 mg/L (ppm) in all cases.

TABLE 10
Water Product Properties

| | | | | Clean |
|---|---|---|---|---|
| | | Laminex:Blue | Blue Pine | Timber |
| Properties | | 50:50 | 100% | 100% |
| Date of Manufacture (2015) | | 7 January | 7 January | 15 January |
| Acidity | pH | 3.9 | 1.9 | 2.06 |
| | Acetic Acid | 4.6% | 5.5% | 5.8% |
| Type 1 Metals | Antimony Sb | 0.03 | 0.012 | 0.014 |
| | Arsenic As | 0.173 | 0.3 | 0.12 |
| | Cadmium Cd | 0.0002 | 0.0004 | 0.0002 |
| | Lead Pb | 0.023 | 0.108 | 0.007 |
| | Mercury Hg | 0.004 | 0.037 | 0.061 |
| | Total Type 1 | 0.234 | 0.456 | 0.202 |
| Type 2 Metals | Beryllium Be | <0.001 | <0.001 | <0.001 |
| | Chromium Cr | −0.004 | 0.017 | 0.003 |
| | Cobalt Co | <0.001 | 0.001 | <0.001 |
| | Manganese Mn | 0.021 | 0.03 | 0.007 |
| | Nickel Ni | 0.012 | 0.053 | 0.006 |
| | Seleium Se | <0.001 | <0.001 | <0.001 |
| | Tin Sn | <0.001 | <0.001 | <0.001 |
| | Vanadium V | <0.001 | 0.001 | <0.001 |
| | Total 2 | 0.037 | 0.1 | 0.016 |
| Type 1 and 2 | Total 1 and 2 | 0.271 | 0.557 | 0.216 |
| Recoverable | C6-C10 | 78.5 | 105 | 136 |
| Hydrocarbons | >C10-C16 | 8.560 | 7.580 | 5.420 |
| (excl. TBEXN) | >C16-C34 | 136 | 153 | 101 |
| | >C34-C40 | <0.15 | <0.15 | <0.15 |
| | Total C6-C40 | 0.88% | 0.78% | 0.57% |
| BTEXN | Benzines | 1.14 | 1.87 | 2.78 |
| | Ethylbenzene | 0.098 | 0.142 | 0.125 |
| | Toluene | 0.94 | 1.34 | 1.19 |
| | Xylenes | 0.343 | 0.391 | 0.343 |
| | BTEX Total | 2.52 | 3.7 | 4.44 |
| | Naphthalene | 1.92 | 6.52 | 8.19 |
| | BTEXN Total | 4.44 | 10.2 | 12.6 |

All units mg/L (approx. ppm) except acid and total recoverable hydrocarbons in %
These analyses are of the water condensate direct from the converter which is further refined by separation of any residual oils and tars prior to application in the field. During this period the BTEXN have been shown to be biodegradable.

### 6.4 Trace Metal Deportment

The distribution of trace metals between the products can be calculated from the char, gas and water analyses presented above, Table 8, Table 9 and Table 10, based on the relative yields of char, gas and water.

The calculations have been carried out for the 50:50 Laminex:Blue Pine blend feedstock, since this is the one where trace metals have been analysed for all three products. Back-calculating from the product analyses, the estimated feedstock trace metal concentrations are shown in the table below:

TABLE 11
Feedstock Trace Metals

| | Feedstock Concentration mg/kg | |
|---|---|---|
| Trace Metals | (ppm dry weight basis) | |
| Type 1 | 3.1 | ppm |
| Type 2 | 76.3 | ppm |
| Total 1 and 2 Total | 79.4 | ppm |

On the same assumptions, calculations of the relative deportment of trace metals to the three co-products were made and are shown in Table 12 below:

TABLE 12
Deportment of Trace Metals to the Products,
% of Original Feedstock Content

| Department | Type 1 | Type 2 | Type 1 and 2 Total |
|---|---|---|---|
| To Char | 96.5% | 99.93% | 99.8% |
| To Water | 2.61% | 0.017% | 0.12% |
| To Gas | 0.87% | 0.052% | 0.08% |

The following observations are noted about trace metal deportment:
Type 1 and 2 metals report predominantly to the char product (99.8% in total);
Metals can only end up in the gas or water products via the gas phase; Type 1 metals are generally more volatile than Type 2 metals, hence their slightly higher deportment to the gas and water. Even in the case of Type 1 metals, some 96.5% report to the char; and
This is positive evidence for the proposition that the low exit temperature of the gas does not favour volatilisation of metals from the incoming feed, and even where some volatilisation occurs, most of the metal reports to the water product, not the gas.

### B. Trials on Contaminated Wood Wastes—Impact of Plastics Materials

### Feed Preparation

Trials were conducted with wood wastes blended with different amounts of plastics materials.

Table 13 summarises the plastics components:

TABLE 13
Components

| | Proportion | |
|---|---|---|
| Components | (dry weight) | Constituents |
| Plastic | 0, 3, 5, 7 wt. % | 30% LDPE, 30% HDPE, 30% PP, |
| | | 10% HIPS, Astron Plastics, Ingleburn |

The wood waste was also prepared to the following feed material specification of the applicant:
total moisture content <15%.
size: minus 20 mm and <10% minus 1 mm.

The wood waste was blended with clean wood waste to produce three blends, one blend having 3 wt. % plastics material, a second blend having 5 wt. % plastics material, and a third blend having 7 wt. % plastics material.

### Trial Procedure

In total, six processing trials were conducted at around 300 kg/hr, with an accumulated operating period of some 25 hours.

In each trial, after a period of at least 1 hour of stable operation with clean wood waste in the reaction chamber 5 of the converter 3, controlled amounts of plastic materials were added each minute to the metering screw of the feed hopper of the apparatus. The additions corresponded to 3 wt. %, 7 wt. % and 9 wt. % plastics materials in the wood wastes.

It was found in the trials that, in this range of plastics additions, stable operations and effective carbonisation were achieved. In other words, the plastics materials did not impact negatively on process stability.

### Effective Carbonisation

The degree of carbonisation (char making) is an indicator of the effectiveness of the apparatus in processing wood wastes. The reason for this is that, if there is effective decomposition of the lignin, cellulose and hemi-cellulose to char, it follows that biota cannot survive and the various organics in the food, plastic and paper will also decompose.

Table 14 summarises the carbonisation of the SFCW/wood blends and a comparative example for 100% wood.

TABLE 14
Carbonisation Results

| | | 3% | 5% | 7% |
|---|---|---|---|---|
| Char Properties | Clean | plastics | plastics | plastics |
| (DAF basis) | Wood | materials | materials | materials |
| Calorific Value | 33.8 | 33.4 | 33.4 | 33.3 |
| (GJ/t) | | | | |
| Volatile Matter | 10.2 | 9.8 | 12.1 | 13.4 |
| (%) | | | | |
| Carbon (%) | 90 | 90 | 89 | 88 |
| Hydrogen (%) | 2.3 | 2.0 | 2.4 | 2.4 |
| Oxygen (%) | 5.6 | 5.8 | 6.4 | 6.7 |

A dry ash-free (DAF) calorific value above 30 GJ/t is a measure of effective carbonization. The addition of plastics to wood in wood wastes up to 7 wt. % in the wood wastes did not compromise the carbonisation process (DAF CV >33 GJ/t in all cases).

Process Stability

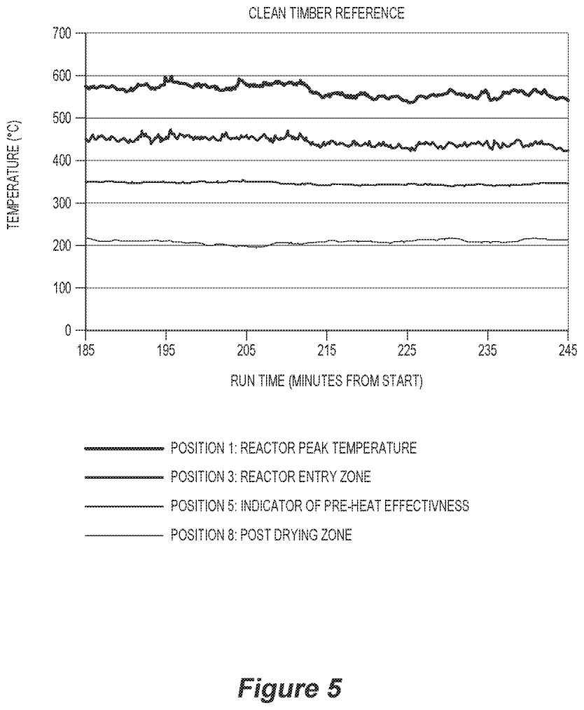

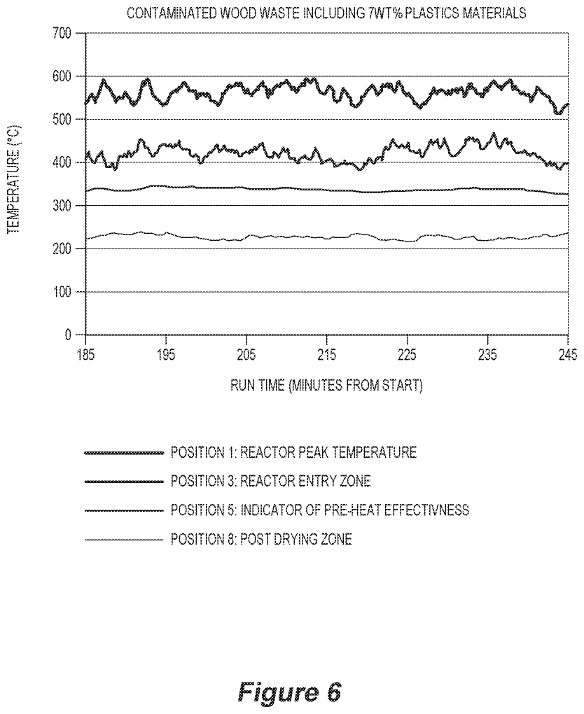

It was clear from the trial data, for example FIGS. 5 and 6, that the addition of plastics up to 7 wt. % in the wood wastes (i.e. up to 7 wt. % plastics materials) in the wood wastes did not compromise process stability.

The control system of the apparatus made adjustments to the operating parameters in response to the changes in feed properties (composition and packing density).

For instance, the solids moved more slowly through the apparatus with up to 7 wt. % plastics in the wood wastes) compared to the 100% wood product, but the net production rate was higher due to the increased packing density of the blend.

FIGS. 5 and 6 are temperature-time graphs for 1 hour periods of trials with 0 and 7 wt. % wood wastes, i.e. 100 wt. % wood waste and wood waste with 7 wt. % plastics material, at different positions along the length of the reactor.

It is clear from the Figures that the temperature profiles at the same positions are similar.

The data showed the same results with the other trials.

### Temperature-Time

As discussed above, FIG. 2 shows the temperature-time profiles of trials with four different feed materials, the feed materials of each trial having different amounts of plastics material. Four of the plots in FIG. 2 are for trials on 0, 3 wt. %, 5 wt. %, and 7% wood wastes.

As discussed above, FIG. 2 shows that the temperature of the feed material in each trial increases steadily to approximately 250° C. after 8 minutes within the reaction chamber 5.

The temperature of the feed material that had no quarantined material increased quickly generally linearly from this point during the next 4 minutes to 600° C.

FIG. 2 also shows similar sharp increases in temperature at later start times, with the start times being a function of the increasing proportions of quarantined material (including plastics materials) in the feed materials.

From a process management perspective, one of the key factors is “time at temperature” for the solids travelling through the reaction chamber 5 of the converter 3.

For perspective, the distance the solids travel from feed entry to char discharge is some 4 m and there was a total residence time of solids inside the apparatus is around 15 minutes.

On the journey through the reaction chamber 5, the solids are first fully dried, then pre-heated and finally carbonised in the reactor section.

The times at temperatures for effective thermal decomposition of wood and the plastics and other organics in the catering waste (300-600° C.), were not compromised (ca 5 minutes) by the presence of the plastics materials).

The times at temperature are illustrated by Table 15 below.

TABLE 15

| | | 3% | 5% | 7% |
|---|---|---|---|---|
| Plastics in wood | 0% | plastics | plastics | plastics |
| wastes | plastics | materials | materials | materials |
| Total Time in CBC | 13.4 | 14.6 | 14.0 | 16.8 |
| Time above 100° C. | 11.3 | 13.0 | 12.4 | 14.9 |
| Time above 200° C. | 7.4 | 8.6 | 8.0 | 10.3 |
| Time above 300° C. | 5.0 | 5.2 | 5.0 | 4.6 |
| Time above 400° C. | 3.5 | 3.3 | 3.0 | 3.4 |
| Time above 500° C. | 2.3 | 2.0 | 2.3 | 2.6 |

As an approximation, and having regard to FIG. 2, the first third of the journey through the reaction chamber 5 of the converter 3, i.e. Zone 1, dries the feed material (with solids reaching temperatures of 100-150° C.), the second third, i.e. Zone 2, preheats the feed material (to 250-300° C.), and the final section, i.e. Zone 3, is where the bulk of the thermo-chemical reactions take place with peak temperatures in the reactor reaching around 650° C.

### Products

The trials produced valuable solid char, wood vinegar (i.e. a water-based condensate), and gas products. These are commercially valuable products

In particular, the analysis of the trials showed that the gas generated from processing 7 wt. % plastics is clean burning, with all emission monitoring parameters, except NOₓ and HCl, well below the Australian EPA Group 6 standards, without a gas cleaning step prior to combustion. There are counter-measures available for the NOₓ and HCl emissions.

The results are summarised in Table 16 below.

| Gas Combustion | EPA | Emissions |
|---|---|---|
| Parameters | Group 6 Limits | (7% plastics materials) |
| Smoke (Opacity) | 20% | No visible smoke |
| Particulates | 50 | 24 |
| VOC's (as n-propane) | 40 | 5.4 |
| Chlorine | 200 | <0.07 |
| Fluorides (as HF) | 50 | <0.08 |
| Hydrogen Chloride | 100 | 490 |
| Hydrogen Sulphide | 5 | <0.5 |
| Type 1 and 2 Metals Total | 1 | 0.098 |
| Cadmium | 0.2 | <0.0006 |
| Mercury | 0.2 | <0.0002 |
| Dioxins/Furans (ng/Nm³ TEQ) | 0.1 | 0.012 |
| Noₓ (as NO₂) | 450 | 560 |
| Sulphuric Acid Mist (as SO₃) | 100 | 25 |
| Sulphur Dioxide | 1,000 | 140 |

The VOC's and dioxins/furans data in the above table is particularly relevant to the plastics materials.

Many modifications may be made to the embodiment of the method and the apparatus of the present invention shown in the drawings without departing from the spirit and scope of the invention.

By way of example, whilst the embodiment described in relation to the drawings includes three parallel rotatable shafts 17 and interleaved screw feeders 19 on the shafts 17, the invention is not limited to this arrangement and extends to any alternative arrangements for moving feed material along the chamber 5 and is not limited to this number of rotatable shafts 17 and interleaved screw feeders 19.

By way of further example, whilst the embodiment described in relation to the drawings includes particular forms of the intruder 21 and the extruder 23, the invention is not limited to this arrangement and extends to any alternative arrangements for supplying feed material to the chamber 5 and discharging solid product from the chamber 5 which creates effective gas seals for the chamber 5.

By way of further example, whilst the embodiment described in relation to the drawings includes a particular feed assembly 11 for controlling the flow of feed material from the intruder 21 to the inlet 41 of the reaction chamber 5, the invention is not limited to this arrangement and extends to any suitable alternative arrangements.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

1. An apparatus for processing wood wastes and producing valuable products that are safe and have economic value, the apparatus including a continuous converter for a feed material that includes wood wastes containing contaminants, with the continuous converter including a reaction chamber for producing a solid carbon-containing product, a gas product, and optionally a liquid oil product and a separate water-based condensate product in the chamber, via pyrolysis or other reaction mechanisms, an inlet for supplying the feed material to the reaction chamber, an assembly for moving the feed material through the reaction chamber from the upstream end towards the downstream end of the chamber counter-current to the flow of gas generated in the chamber as a consequence of drying or other reactions in the chamber, and separate outlets for the solid carbon-containing product, the gas product, and optionally the liquid water product from the reaction chamber, with the apparatus being adapted to decompose organic material contaminants in the wood wastes and to incorporate the decomposed forms into useful products, and with the apparatus being adapted to deport heavy metal contaminants to the solid carbon-containing product.

2. The apparatus defined in claim 1 wherein the continuous converter includes an assembly for establishing a temperature profile in the reaction chamber that includes the following zones extending successively along the length of the reaction chamber from the upstream end to the downstream end of the reaction chamber:
(a) a drying zone (Zone 1) for drying the feed material—typically 60-80° C. is the inlet end temperature and 100-150° C. is the upper temperature limit of Zone 1,
(b) a pre-heating zone (Zone 2) for heating the feed material to a temperature that is suitable for the thermo-chemical reactions required in the next zone—typically 250-300° C. is the upper limit of Zone 2, and
(c) a thermo-chemical reaction zone (Zone 3) for thermally decomposing the feed material and producing a solid carbon-containing, typically char product, and gas.

3. A method for processing wood wastes and producing valuable products that are safe and have economic value in the apparatus described in the preceding paragraph, with the method including the steps of:
(a) supplying a solid feed material that includes wood wastes containing contaminants to the inlet of the reaction chamber of the apparatus;
(b) moving the feed material through the reaction chamber from the inlet to the downstream end of the chamber and exposing the feed material to a time-temperature profile within the chamber that dries and pyrolyses or otherwise processes the feed material and releases water vapour and a volatile products gas phase from the feed material as the feed material moves through the chamber;
(c) moving the water vapour phase and the volatile products gas phase produced by heating the feed material in step (b) through the reaction chamber in a direction counter to that of the feed material so that at least a part of the water vapour phase and the condensable components of the volatile products gas phase condense in cooler upstream sections of the reaction chamber and form liquid water and liquid oil, at least the liquid oil being carried forward in the reaction chamber by the feed material to the higher temperature regions of the reaction chamber and being progressively volatilised and cracked to a non-condensable gas; and
(d) discharging (i) a gas product and (ii) a dried and pyrolysed solid carbon-containing product from the separate outlets of the chamber, and
with the time-temperature profile within the chamber ensuring that (i) organic material contaminants in the wood wastes are decomposed and the decomposed forms are incorporated into useful products and (ii) heavy metal contaminants in the wood wastes are deported to the solid carbon-containing product.

4. The method defined in claim 3 wherein the wood wastes are in a particulate form having a particle size of minus 25 mm, typically minus 20 mm.

5. The method defined in claim 3 wherein less than 15 wt. %, typically less than 10 wt. %, of the total mass of wood wastes have a particle size of minus 1 mm.

6. The method defined in claim 3 wherein the amount of moisture in the feed material is less than 20 wt. %, more typically less than 15 wt. %, of the total mass of the feed material.

7. The method defined in claim 3 includes controlling the gas product composition by controlling the temperature profile in the reactor and therefore the residence time within a required temperature range.

8. The method defined in claim 3 includes condensing water vapour from the gas product outside the chamber and forming a liquid water product.

9. The method defined in claim 3 includes maintaining a required temperature profile in the reaction chamber by supplying an oxygen-containing gas, such as air, to the reaction chamber and at least partially combusting combustible gases in the reaction chamber.

10. The method defined in claim 3 wherein the temperature profile in the reaction chamber include a plurality of zones successively along the length of the chamber in which different reactions occur as the feed material moves from the upstream cooler end to the downstream hotter end of the reaction chamber.

11. The method defined in claim 10 includes establishing a temperature profile in the reaction chamber that includes the following zones extending successively along the length of the reaction chamber from the upstream end to the downstream end of the reaction chamber:
(a) a drying zone (Zone 1) for drying the feed material—typically 60-80° C. is the inlet end temperature and 100-150° C. is the upper temperature limit of Zone 1,
(b) a pre-heating zone (Zone 2) for heating the feed material to a temperature that is suitable for the thermo-chemical reactions required in the next zone—typically 250-300° C. is the upper limit of Zone 2, and
(c) a thermo-chemical reaction zone (Zone 3) for thermally decomposing the feed material and producing a solid carbon-containing, typically char product, and gas.

12. The method defined in claim 3 includes supplying the oxygen-containing gas, such as air, to the reaction chamber in Zone 3, whereby the devolatilization produces combustible gases that are combusted by the oxygen-containing gas. Supplying the oxygen-containing gas in this region of the reaction chamber optimises the combustion of combustible gases.
